(19) United States
(12) Patent Application Publication
(10) Pub. No.: US 2024/0164006 A1
(43) Pub. Date: May 16, 2024

(54) Compact Atomic Beam Generator

(71) Applicant: Georgia Tech Research Corporation, Atlanta, GA (US)

(72) Inventors: Chandra Raman, Atlanta, GA (US); Yorick Andeweg, Atlanta, GA (US); Alexandra Crawford, Atlanta, GA (US); Chao Li, Atlanta, GA (US); Bochao Wei, Atlanta, GA (US)

(21) Appl. No.: 18/162,959

(22) Filed: Feb. 1, 2023

Related U.S. Application Data
(60) Provisional application No. 63/305,439, filed on Feb. 1, 2022.

(51) Int. Cl. H05H 3/02

(52) U.S. Cl. CPC H05H 3/02

(57) ABSTRACT

An exemplary embodiment of the present disclosure provides a collimated atomic beam generator. The generator can comprise an atomic vapor chamber, a collimator plate, and an insulative adhesive layer. The atomic vapor chamber can comprise an atomic vapor source. The collimator plate can comprise a first side facing the atomic vapor chamber, an opposing second side, and a plurality of channels extending between the first side and the second side. The insulative adhesive layer can be positioned between and coupling the atomic vapor chamber to the collimator plate. The collimator plate can be configured to collimate atomic vapors generated by the atomic vapor source in the atomic vapor chamber.

### CROSS-REFERENCE TO RELATED APPLICATIONS

This application claims the benefit of U.S. Provisional Application Ser. No. 63/305,439, filed on 1 Feb. 2022, which is incorporated herein by reference in its entirety as if fully set forth below.

### GOVERNMENT LICENSE RIGHTS

This invention was made with government support under Agreement No. 2011478, awarded by National Science Foundation, Agreement No. FA9550-19-1-0228, awarded by Air Force Office of Naval Research, and Agreement No. N00014-20-1-2429, awarded by Office of Naval Research. The government has certain rights in the invention.

### FIELD OF THE DISCLOSURE

The various embodiments of the present disclosure relate generally to atomic beams and systems and methods of generating atomic beams.

### BACKGROUND

Alkali atoms are a key resource for numerous emerging chip-scale quantum technologies. With the ease of batch fabrication methods, chip-based atomic devices, such as vapor cell atomic clocks and magnetometers, quantum gravimeters, and Bose-Einstein condensates on-chip, have become increasingly attractive for realizing quantum device architectures that can be more widely disseminated. As this miniaturization trend continues, there is a growing need to integrate small-scale alkali atom sources directly on-chip or within a small volume vacuum cell. Alkali metal dispensers can be small in size and can be handled in ambient air. However, the high temperature needed to initiate the reactions that produce alkali vapor (e.g., 550-850° C.) creates significant challenges for integration into a chip environment, as they present a considerable source of radiative heat that can influence other chip components. Moreover, at such elevated temperatures, the emitted atomic flux from a dispenser has a substantial longitudinal velocity and must first thermalize with room temperature surfaces in order to be captured in a magneto-optical trap. For this reason, dispenser activation and subsequent utilization of the rubidium vapor are often performed in two separate steps. But this can be particularly problematic for miniature applications demanding line-of-sight to the alkali source. For these applications, in addition to the thermal issues discussed above, the broad angular distribution of alkali vapor emitted from a bare dispenser can be unacceptable because it can degrade the signal-to-noise ratio as well as contaminate nearby electronic or photonic components. Accordingly, there is a need for improved atomic beam generating systems and methods that can be used in applications requiring compact components.

### BRIEF SUMMARY

An exemplary embodiment of the present disclosure provides a collimated atomic beam generator. The generator can comprise an atomic vapor chamber, a collimator plate, and an insulative adhesive layer. The atomic vapor chamber can comprise an atomic vapor source. The collimator plate can comprise a first side facing the atomic vapor chamber, an opposing second side, and a plurality of channels extending between the first side and the second side. The insulative adhesive layer can be positioned between and coupling the atomic vapor chamber to the collimator plate. The collimator plate can be configured to collimate atomic vapors generated by the atomic vapor source in the atomic vapor chamber.

In any of the embodiments disclosed herein, the atomic vapor source can comprise an alkali dispenser.

In any of the embodiments disclosed herein, the alkali dispenser can be a Rubidium chromate dispenser.

In any of the embodiments disclosed herein, the insulative adhesive layer can be configured to provide thermal shielding to the collimator plate from the atomic vapor chamber.

In any of the embodiments disclosed herein, the insulative adhesive layer can be configured to provide electrical shielding to the collimator plate from the atomic vapor chamber.

In any of the embodiments disclosed herein, the adhesive layer can create a hermetic seal between the atomic vapor chamber and the collimator plate.

In any of the embodiments disclosed herein, the insulative adhesive layer can have a thickness of between 0.5 mm and 5.0 mm.

In any of the embodiments disclosed herein, the plurality of channels can have a first end proximate the first side of the collimator plate and a second end proximate the second side of the collimator plate. A cross-sectional area of the channels proximate the first ends can be greater than a cross-sectional area of the channels proximate the second ends.

In any of the embodiments disclosed herein, the insulative adhesive layer can comprise a ceramic adhesive.

In any of the embodiments disclosed herein, the ceramic adhesive can comprise a dispersion of aluminum oxide in an inorganic silicate aqueous solution.

In any of the embodiments disclosed herein, the insulative adhesive layer can have a thermal conductivity of between 0 and 35 Watts/meter-Kelvin.

In any of the embodiments disclosed herein, the insulative adhesive layer can have an electrical conductivity of between 0 and 100,0000 Siemens/meter.

In any of the embodiments disclosed herein, the generator can further comprise a current input and a current output electrically coupled to the atomic vapor chamber. An electrical current received at the current input can traverse through the atomic vapor chamber to stimulate the atomic vapor source and exit the current output.

Another embodiment of the present disclosure provides a collimated atomic beam generator. The generator can comprise an atomic vapor chamber, a collimator plate, an insulative layer, a current input, and a current output. The atomic vapor chamber can comprise an atomic vapor source. The collimator plate can comprise a plurality of channels extending therethrough. The insulative layer can be positioned between and couple the collimator plate to the atomic vapor chamber. The current input can be electrically coupled to the atomic vapor chamber. The current output can be electrically coupled to the atomic vapor chamber. An electrical current received at the current input can traverse through the atomic vapor chamber to stimulate the atomic vapor source and exit the current output. The atomic vapor source can be configured to generate an atomic vapor in response to the electrical stimulus. The collimator plate can be configured to collimate the atomic vapor as it passes through the plurality of channels.

These and other aspects of the present disclosure are described in the Detailed Description below and the accompanying drawings. Other aspects and features of embodiments will become apparent to those of ordinary skill in the art upon reviewing the following description of specific, exemplary embodiments in concert with the drawings. While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments discussed herein. In similar fashion, while exemplary embodiments may be discussed below as device, system, or method embodiments, it is to be understood that such exemplary embodiments can be implemented in various devices, systems, and methods of the present disclosure.

### BRIEF DESCRIPTION OF THE DRAWINGS

The following detailed description of specific embodiments of the disclosure will be better understood when read in conjunction with the appended drawings. For the purpose of illustrating the disclosure, specific embodiments are shown in the drawings. It should be understood, however, that the disclosure is not limited to the precise arrangements and instrumentalities of the embodiments shown in the drawings.

FIG. 1 provides a cross-sectional view of a collimated atomic beam generator, in accordance with an exemplary embodiment of the present disclosure.

FIG. 2A provides a schematic cross-sectional view of a collimated atomic beam generator in which length of the collimator plate is 18 mm and 46 channels (not all shown) span across 7.2 mm to cover the active length of the dispenser, in accordance with an exemplary embodiment of the present disclosure. FIG. 2B provide images of the entrance (facing dispenser) and exit (facing away from dispenser) channel shape, for the exemplary atomic beam generator shown in FIG. 2A. FIG. 2C provides a CCD image of atomic beams fluorescence in the exemplary atomic beam generator shown in FIGS. 2A-B. The laser beam enters from the right and the atomic beams are traveling toward the top. A white line is added at the position of the collimator edge, and it also shows the initial span of the atomic beams (7.2 mm).

FIG. 3A provides a plot of measured fluorescence spectrum with the ⁸⁷Rb saturated absorption spectrum for an exemplary embodiment of the present disclosure. FIG. 3B shows a plot of the transverse velocity distribution after deconvolution, including both the ideal symmetric shape and the discrepancy around negative 200 m/s, which results from the influence of F=2 to F′=2, 1 transitions.

FIG. 4A provides a plot of the recovery signal of the time of flight measurement, in an exemplary embodiment of the present disclosure. Time zero is when the pump laser pulse is switched off. The fitted curve assumes a Maxwell distribution with u=302 m/s. The inset is the diagram for the time of flight set up. FIG. 4B provides a zoomed-in plot for the signal of slow atoms between 44.5 and 70 m/s (the flat substantially horizontal line is the theory curve).

FIG. 5 provides throughput versus time curves for an exemplary atomic beam generator of the present disclosure. Curves with a current of 5.5, 7.5, and 8.2 A are labeled and currents higher than 8.2 A exhibited similar dynamics. Overnight, the laser scan region drifted out of the ⁸⁷Rb D₂ F=2 to F′=3 transition and caused a gap in the 5.5 A data.

FIG. 6A provides a CAD drawing of an exemplary atomic beam oven assembly (I. KF40 bored blank; II. Power feedthrough; III. Stainless steel tube; IV. Crimp connectors; V. Dispenser; VI. CNC machined holder with an EDM slit at the center for hosting the silicon collimator; and VII. An ordinary silicon collimator). FIG. 6B provides a plot of total throughput of the atomic beam oven versus dispenser current. FIG. 6C provides a plot of measured fluorescence spectra, in which the FWHM for 5 and 7 A are both 50 MHz. FIG. 6D provides a plot of measured fluorescence spectra when the laser beam is tilted around α=22° as shown in the inset.

### DETAILED DESCRIPTION

To facilitate an understanding of the principles and features of the present disclosure, various illustrative embodiments are explained below. The components, steps, and materials described hereinafter as making up various elements of the embodiments disclosed herein are intended to be illustrative and not restrictive. Many suitable components, steps, and materials that would perform the same or similar functions as the components, steps, and materials described herein are intended to be embraced within the scope of the disclosure. Such other components, steps, and materials not described herein can include, but are not limited to, similar components or steps that are developed after development of the embodiments disclosed herein.

Disclosed herein are compact techniques for the generation of directed atomic beams from an alkali dispenser, which can be useful for miniature applications demanding line-of-sight to the alkali source. As discussed above, for such applications, the broad angular distribution of alkali vapor emitted from a bare dispenser can be unacceptable because it can degrade the signal-to-noise ratio as well as contaminate nearby electronic or photonic components. In certain embodiments disclosed herein, however, laser micromachined holes in a collimator plate can deliver atoms primarily in the forward direction. Further, as the beam is generated, atoms can rapidly thermalize with the collimator to a considerably lower temperature, as determined by measurements of the longitudinal velocity. Combined with its small size, this collimated source can be easily packaged close to other chip-scale components. The devices disclosed herein have many applications, including in targeted delivery of neutral atoms to microscopic volumes on-chip, such as on-chip cavities or nanophotonic devices for cavity QED.

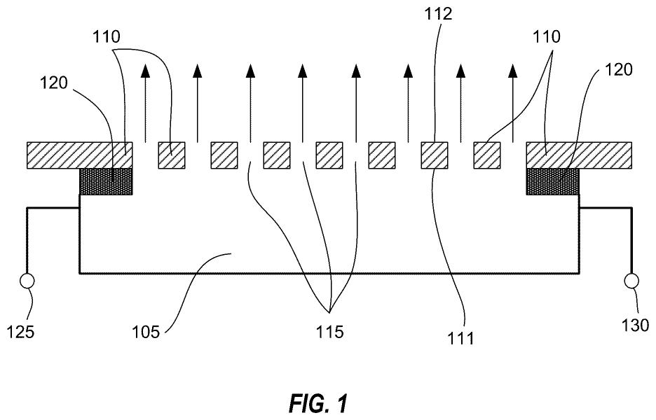

As shown in FIG. 1, an exemplary embodiment of the present disclosure provides a collimated atomic beam generator system. The system can comprise an atomic vapor chamber 105, a collimator plate 110, and an insulative adhesive layer 120. The atomic vapor chamber 105 can comprise an atomic vapor source (not shown). The atomic vapor source can emit atomic vapors. In some embodiments, the atomic vapors can exit the atomic vapor chamber through an aperture in the chamber 105. The aperture can have many different shapes in accordance with various embodiments of the present disclosure. Additionally, the cross-sectional shape and are of the aperture can vary in accordance with various embodiments of the present disclosure.

The atomic vapor source can be many different atomic vapor sources known in the art. In some embodiments, the atomic vapor source can comprise an alkali dispenser, including, but not limited to, a rubidium (Rb) or rubidium chromate dispenser.

The collimator plate can comprise a first side 111 facing the atomic vapor chamber 105, an opposing second side 112, and a plurality of channels 115 extending between the first side and the second side. The collimator plate 110 can be configured to collimate atomic vapors generated by the atomic vapor source in the atomic vapor chamber 105. The plurality of channels 115 can have a first end proximate the first side 111 of the collimator plate 110 and a second end proximate the second side 112 of the collimator plate 115. The cross-sectional areas of the channels 115 perpendicular to the length of the channels can vary along the length of the channels 115. For example, in some embodiments, a cross-sectional area of the channels 115 proximate the first ends can be greater than a cross-sectional area of the channels 115 proximate the second ends. Additionally, the cross-sectional shapes of the channels 115 can vary along their lengths. For example, in some embodiments, the first ends of the channels 115 can have a substantially circular cross-sectional shape, while the second ends of the channels can have a substantially elliptical cross-sectional shape. The channels 115 can have varying aspect ratios, e.g., 1:1 to 100:1, in accordance with various embodiments of the present disclosure. For example, in embodiments where a higher degree of collimation is desired, the channels 115 can have a higher aspect ratio. In some embodiments, the cross-sectional areas of the channels can also vary among the channels in the collimator plate. For example, a first channel in the plurality of channels 115 can have a cross-sectional area at its first end that is greater than that of a second channel in the plurality of channels 115.

Additionally, the collimator plate 110 can have a varying number of channels 115, in accordance various embodiments of the present disclosure. Further, the channels can be arranged in a single row or multiple rows (e.g., matrix), in accordance with various embodiments of the present disclosure. The spacing between the channels can also vary in accordance with various embodiments of the present disclosure. In some embodiments, the channels can be evenly spaced across the collimator plate corresponding to the active area of the atomic vapor source.

The insulative adhesive layer 120 can be positioned between and couple the atomic vapor chamber 105 to the collimator plate 110. The insulative adhesive layer 120 can be configured to provide thermal and/or electrical shielding to the collimator plate from the atomic vapor chamber. Thus, the insulative layer can create a temperature differential between the atomic vapor chamber 105 and the collimator plate 110 (e.g., higher temperature at the atomic vapor chamber 105 than the collimator plate 110). The adhesive layer 120 can also create a hermetic seal between the atomic vapor chamber 105 and the collimator plate 110, such that atomic vapors created in the atomic vapor chamber 105 do not exit the system between the atomic vapor chamber and the collimator plate; rather, those vapors would traverse through the channels 115 of the collimator plate 110 to form atomic beams.

An advantage of embodiments of present disclosure over conventional devices, is that the insulative layer can have a smaller thickness while surprisingly achieving the desired electrical and thermal shielding between the atomic vapor chamber and the collimator plate. The thickness of the insulative adhesive layer can vary in accordance with various embodiments of the present disclosure. For example, the insulative layer can have a thickness of less than 10 mm, less than 9 mm, less than 8 mm, less than 7 mm, less than 6 mm, less than 5 mm, less than 4 mm, less than 3 mm, less than 2 mm, or less than 1 mm. In some embodiments, the insulative layer can have a thickness of between 0.1 mm and 10 mm, or between 0.5 mm and 5.0 mm.

The insulative adhesive layer can be many insulative adhesives known in the art. In some embodiments, the insulative adhesive layer can comprise a ceramic adhesive. In some embodiments, the ceramic adhesive can comprise a dispersion of aluminum oxide in an inorganic silicate aqueous solution (such as the adhesive sold under the trademark PELCO®).

Depending on the desired application, the insulative layer can have varying degrees of thermal and electrical conductivity. For example, the insulative adhesive layer can have a thermal conductivity of between 0 and 35 Watts/meter-Kelvin, including all subranges within that range. For example, in accordance with various embodiments, the insulative adhesive layer can have a thermal conductivity of at least 1, at least 5, at least 10, at least 15, at least 20, at least 25, or at least 30 Watts/meter-Kelvin and/or no more than 35, no more than 30, no more than 25, no more than 20, no more than 15, no more than 10, or no more than 5 Watts/meter-Kelvin. The insulative layer can have an electrical conductivity of between 0 and 100,0000 Siemens/meter, including all subranges within that range. For example, in accordance with various embodiments, the insulative adhesive layer can have an electrical conductivity of at least 1, at least 50, at least 100, at least 500, at least 1,000, at least 5,000, at least 10,000, at least 25,000, at least 50,000, or at least 75,000 Siemens/meter and/or no more than 75,000, no more than 50,000, no more than 25,000, no more than 10,000, no more than 5,000, no more than 1,000, no more than 500, no more than 100, or no more than 50 Siemens/meter.

As shown in FIG. 1, the generator can further comprise a current input 125 and a current output 130. The current input 125 and current output 130 can be electrically coupled to the atomic vapor chamber 105 so allow an electrical current to pass through the atomic vapor chamber 105 and stimulate the atomic vapor source. For example, an electrical current received at the current input 125 can traverse through the atomic vapor chamber 105 to stimulate the atomic vapor source and exit the current output 130. Stimulation of the atomic vapor source can cause the atomic vapor source to emit atomic vapors in the atomic vapor chamber 105.

As discussed above, the insulative layer can serve to provide electrical and thermal shielding between the atomic vapor chamber 105 and the collimator plate 110. This can result in a decreased velocity of the atomic vapors that exit the collimator plate, which can be a desirable feature. For example, in some embodiments, the atomic vapors exiting the collimator plate can have an average peak velocity of between 250 and 400 m/s, including all subranges within that range. For example, in accordance with various embodiments, the atomic vapors exiting the collimator plate can have an average peak velocity of at least 250, at least 275, at least 300, at least 325, at least 350, or at least 375 m/s and/or no more than 400, no more than 375, no more than 350, no more than 325, no more than 300, or no more than 275 m/s.

### EXAMPLES

Below, certain exemplary embodiments are described, by way of example only. These embodiments do not limit the scope of the disclosure herein.

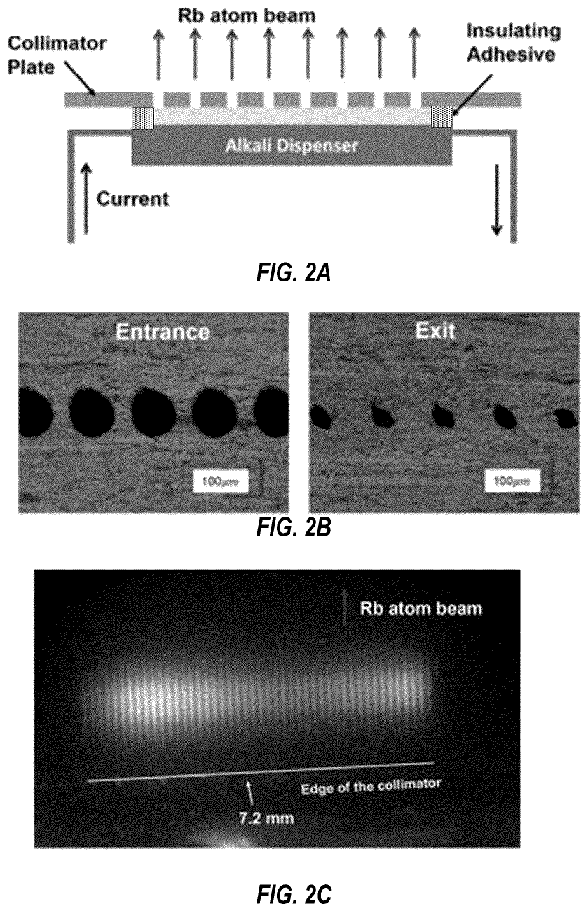

SAES alkali metal dispensers were used as the atomic source. It holds a mixture of rubidium chromate and a reducing agent within a metal container, which has a trapezoidal cross section with a small slit to allow alkali metal vapor to exit. The active area of the dispenser is around 6×1 mm². The apparatus is shown schematically in FIG. 2A. A 600 μm thick stainless steel plate with micro-channels is used to collimate the emitted rubidium atoms. This collimator plate is fabricated using the femtosecond laser micromachining technique (OPTEC WS-Flex USP). There are 46 channels in the center of the plate with a spacing of 160 μm that fully covers the active length of the dispenser. The aspect ratio of the channels is around 6:1. As a result of this aspect ratio and the nature of laser micro-machining, the fabricated channels have a varying diameter across the plate. As shown in FIG. 2B, the entrance diameter is around 115 μm while the exit is an ellipse with 2a≈45 μm and 2b≈70 μm. The plate is positioned with the entrance facing the dispenser to achieve better collimation. The overall device dimensions are around 18×12×2 mm³ and could be further reduced.

A high-temperature ceramic adhesive (PELCO) is applied between the dispenser and the collimator to hold them together while serving as an insulating spacer. This adhesive provides both ultra-low electrical and thermal conductivity so that the current mostly runs through the dispenser and creates a temperature difference between the dispenser and the collimator. The adhesive also seals the space between the dispenser and the collimator to avoid leakage, thereby creating a small cavity that acts as a rubidium reservoir. The off-axis atoms are more likely to return to this reservoir and be saved. Although this procedure can require handling the dispenser in ambient air, we have noticed that the dispensers are not noticeably degraded.

The device was activated by running an 8 A current for around 10 mins. After activation, the current was lowered to around 6 A and a relatively steady flux of rubidium atoms was produced. The operating current is greater than the bare dispenser because of the small exit area (−0.12 mm²) and the extra heat load from the collimator plate and ceramic adhesive.

The device was put inside a cubic vacuum chamber that reached a pressure around 4×10⁴ Torr. Electrical inline connectors and two feed-through pins were used to connect the dispenser to the outside of the chamber. A laser beam was sent perpendicular to the atomic beam direction. Laser spectroscopy at the Rb D₂ line is used to measure the transverse speed distribution. A current of 6.5 A was run through the dispenser, and the fluorescence was collected by using a 2 in. lens set with a numerical aperture around 0.24 and a silicon photodetector (Thorlabs Model DET100A2). The photocurrent passes through a current preamplifier (Model 1211 DL Instruments) with a gain of 10¹ V/A. FIG. 2C is the image of the beam fluorescence with our laser locked to the Rb D₂ F=2 to F′=3 transition. All 46 channels are clearly visible.

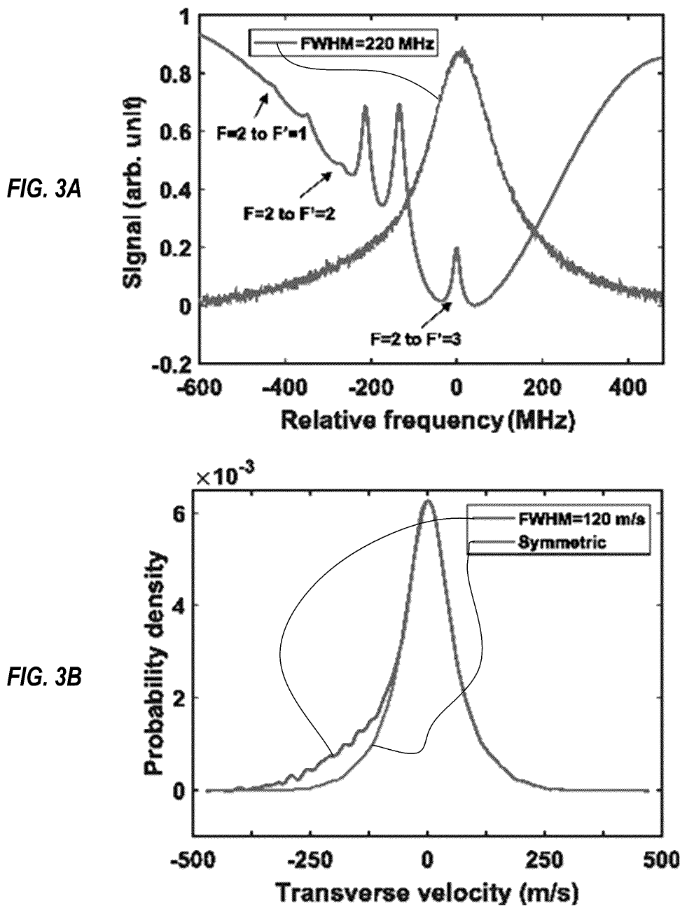

The atomic beam fluorescence spectrum is shown in FIG. 3A together with the saturated absorption spectrum of Rb from a reference cell for identification of the spectral lines. The full width at half maximum (FWHM) is 220 MHz. The spectrum is a convolution between the scattering rate R_{sc} and the atoms' transverse Doppler distribution n(vₜ). Using the deconvolution technique, and given our laser power p=2 mW with beam size w=0.59 mm, we can deduce the transverse speed distribution as shown in FIG. 3B. The FWHM for the transverse speed distribution is around 120 m/s. The deconvolution process here only considered a single F=2 to F′=3 hyperfine level, while the F=2 to F′=2, 1 transitions contribute to the asymmetric shape around −200 m/s.

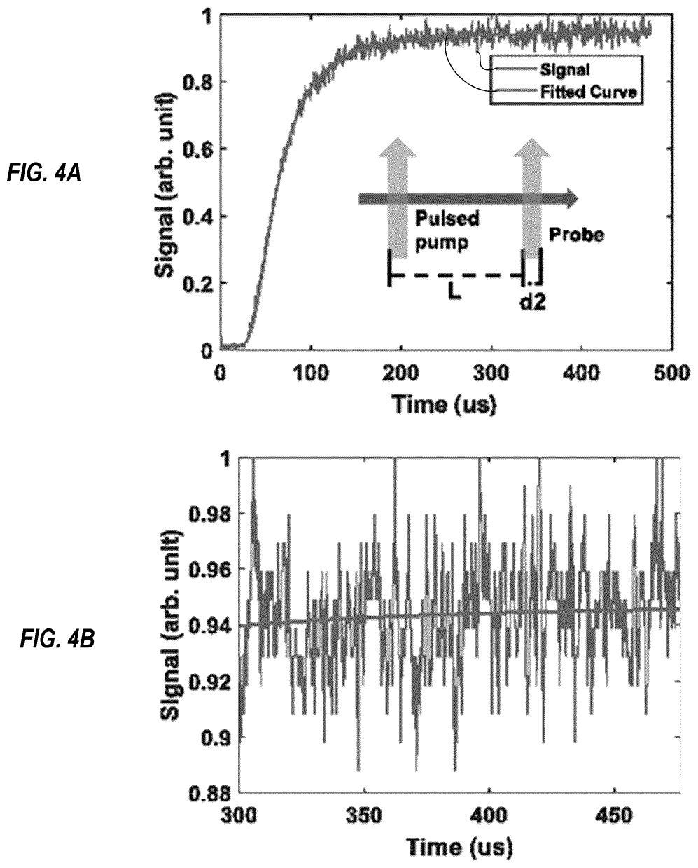

The longitudinal velocity distribution is measured by using a modified time of flight technique. We found this method to be more convenient than measuring the longitudinal Doppler shift spectrally since the latter approach would be easily affected by the transverse velocity distribution, power broadening, and other hyperfine transitions. In our time-of-flight technique, a locked pumping laser is tuned to the Rb D₂ F=2 to F′=2 transition that selects atoms with nearly zero transverse velocity, pumping them into the dark hyperfine ground state F=1 as shown in FIG. 4A inset. A probe beam locked to the Rb D₂F=2 to F′=3 transition is located downstream from the pump. The fluorescence from the probe beam is collected by a micro-photomultiplier tube (Hamamatsu H12403-20). The laser beam separation L=20 mm, while the diameters of both beams are d1=d2=1.2 mm. The dispenser current was increased to 7 A to increase the signal-to-noise ratio. While the pump beam is on, all atoms enter the dark state and the probe fluorescence will be zero. By switching off the pump, atoms in the bright state F=2 will enter the probe region with a time of arrival that depends on their velocity. Thus, following the switch-off, the detector records a time-dependent fluorescence signal S(t) that starts from zero and gradually reaches a steady state. FIG. 4A shows the data. The fluorescence signal in the steady state will depend on the density of atoms in the probe region. Assuming a Maxwell Boltzmann longitudinal speed distribution, the signal can be written as below in Equation 1.

$$S ( v , t ) = \{ \begin{matrix}0 & vi \leq L , \\ c \cdot {v}^{2} \text{?} \cdot ( vt - L ) & L \leq vt \leq L + d 2 \\ c \cdot {v}^{2} \text{?} \cdot d 2 & vt \geq L + d 2.\end{matrix} .$$

$$\text{?} \text{indicates text missing or illegible when filed}$$

in which L is the distance between the pump beam and the probe beam, d2 is the diameter of the probe beam, c is the amplitude factor that does not depend on v, and u=\sqrt{2kT/m} is the most probable speed. Then, the total signal at time t including all velocity groups is as shown below in Equation 2.

$$\begin{matrix}S ( t ) = {\int }_{L / t}^{∞} S ( v , t ) dv \\ = c ( {\int }_{\frac{L}{t}}^{L + d 2 / t} {v}^{2} \text{?} \cdot ( vt - L ) dv + \text{?} {v}^{2} \text{?} \cdot {d}_{2} dv )\end{matrix}$$

$$\text{?} \text{indicates text missing or illegible when filed}$$

This formula is fitted to the signal as shown in FIG. 4, yielding a peak velocity of u=302 m/s, corresponding to a Maxwell Boltzmann distribution with a temperature of around 204° C. This temperature is significantly lower than the expected operating temperature of the dispenser (>600° C.), indicating that the atoms thermalized with the colder surfaces of the collimator plate before exiting the device. Thus, it produces slower atoms on average, compared with the bare dispenser. These findings suggest that direct line-of-sight laser cooling is possible using this integrated dispenser collimator, thus avoiding contamination of the vacuum chamber or miniature cell.

To further quantify the slow atoms, by using d2<<L and

$${v}_{i} = \text{?}$$

$$\text{?} \text{indicates text missing or illegible when filed}$$

in Equation 2, we can get Equation 3 below.

$$S ( {t}_{1} ) - S ( {t}_{2} ) ∼ c \text{?} {v}^{2} \text{?} dv .$$

$$\text{?} \text{indicates text missing or illegible when filed}$$

This means that the difference of S(t) between time t₁, and t₂ is proportional to the density of atoms with velocity v₁ and v₂. FIG. 4B shows the zoomed-in plot between t₁=476 μs; 12=303 μs which corresponds to v₁=44.5 m/s and v₂=70 m/s. By using the fitted S(t) and normalization S(co)−S(0)=1, the atom density within v₁=44.5 m/s and v₂=70 m/s is calculated to be 0.61% of the entire atom density. By comparison, the theoretical ratio for a Maxwell distribution is 0.67%, which is very close to the measured value. To further confirm these observations, the likelihood ratio test was implemented between the null hypothesis and the alternative hypothesis. The null hypothesis is that there are no slow atoms in that velocity range; thus, S(t) should be flat and the observed signal is just Gaussian noise. The alternative hypothesis is that the theoretical Equation 3 is valid for slow atoms, and the observed signal is S(t) plus Gaussian noise. The likelihood ratio of the alternative hypothesis to the null hypothesis is calculated to be 1.1×10⁴. Thus, the signal shows strong evidence for the existence of slow atoms in a thermal beam. These slow atoms are easier to control and can be captured by a MOT downstream or might be used directly for on-chip applications.

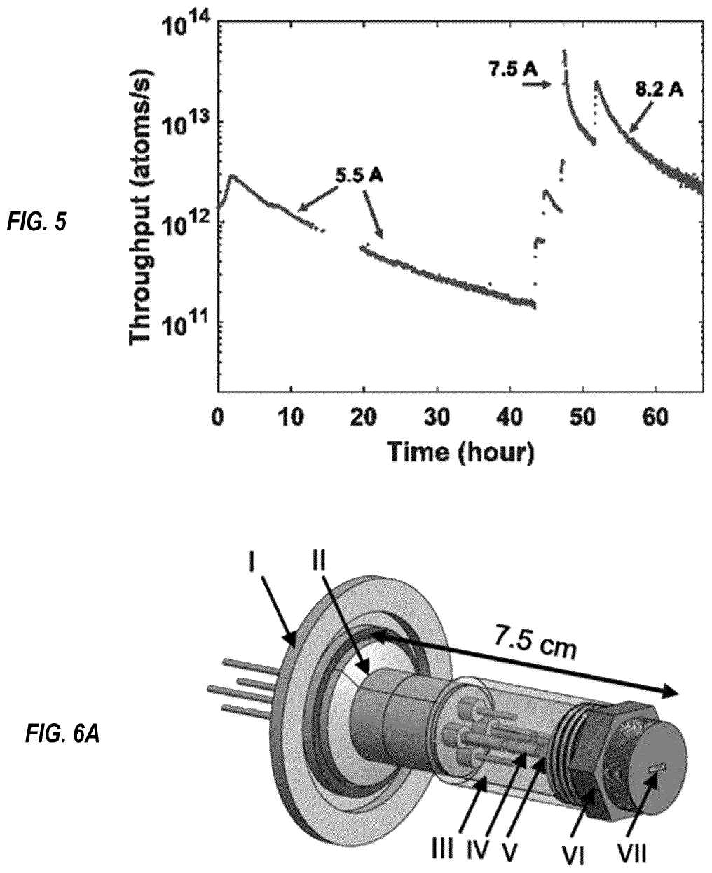

The long-term performance of this device was characterized by monitoring the flux at variable supply currents. The initial current was 5.5 A, and it was increased in steps of ˜0.5 A up to a current of 8.2 A. The total throughput of the device is calculated, and its value at different currents is shown in FIG. 5. With an elevated current through the dispenser, the flux rapidly increased before slowly decreasing on a timescale of hours. This behavior is typical for alkali dispensers, according to its spec sheet. A feedback loop may be integrated into the system to produce a constant flux. After 8.2 A, the input current to the dispenser was gradually increased to 12.8 A to test when the device will fail. After around 20 min at 12.8 A, the collimator plate detached because of the thermal expansion mismatch between the ceramic adhesive and metal surfaces. This indicates the current limit of this exemplary device should be around 12 A.

The total test lasted around 75 h. By integrating the area under the curves, it was calculated that the rubidium emitted during this test is around 0.18 mg. The device lifetime is greatly increased due to the collimator, which blocks and saves the off-axis atoms while maintaining the on-axis flux. Applications requiring higher collimation can use a collimator with a higher aspect ratio and would have an even longer lifetime.

The observations indicate that the hot atoms from the dispenser rapidly thermalize with the collimator plate with a transit distance of only 600 μm. As a result, the temperature of the atoms is lowered by a factor of 3 compared with the bare dispenser. To explore this effect further, a conventional dispenser oven design was built in a stainless steel tube of ¾ in. diameter. It was found that the conventional design performed similarly to the integrated design.

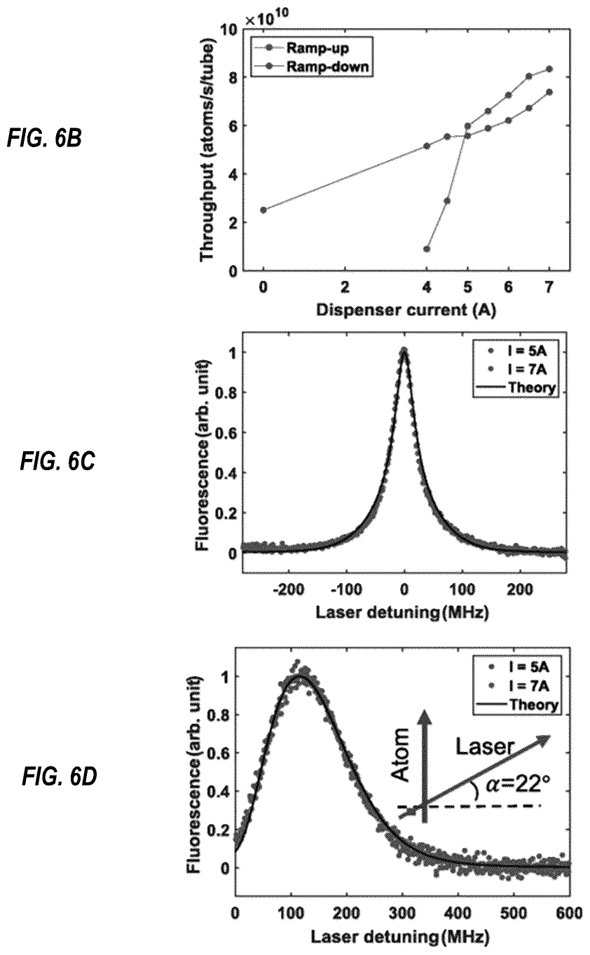

This dispenser oven design is presented in FIG. 6A. A standard center-bored KF40 flange is laser-welded to another electrical KF feed-through. The laser welding region is highlighted in red. Pins for electrical connections are sleeved into a stainless-steel tube with female NPT threads. Another customized copper holder with mating male threads hosting our straight silicon collimator is attached. A conventional silicon collimator design was used, which can provide 30:1 collimation with a size of only 3×5 mm.

A vacuum-compatible polyimide flexible heater is attached to the outside of the stainless-steel tube. A thermistor is glued between parts II and III to serve as the temperature input for a PID controller maintaining the oven body temperature at a set point of 100° C. No heater is needed for the copper head whose temperature was measured to be 121-125° C.

The throughput measurement with different currents is shown in FIG. 6B. Fifteen spectra were taken sequentially as we first ramped up, then ramped down the current of the dispenser. The time step was 5-7 min. The throughput curves for the ramp-up and ramp-down processes do not lie on top of one another. This implies that the time step used was not long enough for the oven to reach equilibrium.

FIG. 6C shows two typical fluorescence spectra taken at 5 and 7 A centered at ⁸⁷Rb D₂ F=2 to F=3. The FWHM at a current of 5 A was 50 MHz, smaller than the 220 MHz value obtained for the integrated design. This is consistent with a factor of 5 larger aspect ratio used −30:1 rather than 6:1 for the stainless-steel collimator. The FWHM for all spectra taken within 5-7 A is in the range of 45-50 MHz, which is roughly the same as previously reported for a 100° C. vapor source based on pure Rb metal.

The transverse velocity spread is narrower in this design, and fluorescence spectroscopy is adequate to measure the longitudinal speed distribution. The laser beam is tilted by α=22° (which was limited by the geometry of the vacuum chamber) with respect to the orthogonal direction of the atomic beam (FIG. 6D). In this case, the fluorescence signal is also sensitive to the longitudinal velocity components. If we assume the longitudinal velocity follows a Maxwell Boltzmann distribution, we can write the fluorescence signal as shown below in Equation 4.

$$V ( δ ) ∝ {\int }_{θ} {\int }_{v} {R}_{sc} ( s , Δ ) F ( v ) κ f ( θ ) dvd θ$$

Here, R_{sc} is the scattering rate function that depends on the saturation parameters and Δ=δ−kv sin (θ+α), δ is the laser detuning from ⁸⁷Rb D₂ F=2 to F=3, v is the atom velocity, θ is the polar angle, a is the tilted angle 22°, F(v) is the Maxwell-Boltzmann distribution with temperature as the fitting parameter, and Kf(θ) is the angular distribution function associated with this silicon collimator, which has been well studied. By fitting the theoretical curve to the experimental data in FIGS. 5C and 5D, it was found that the temperature of F(v) is around 110° C. and the most probable speed is around 270 m/s. The fitted temperature is very close to the average of the measured oven body temperature and copper head temperature. This design allows for monitoring the temperature of the oven and independently confirms that the hot atoms from the dispenser thermalize with the collimator wall and oven wall first before emerging from the collimator.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way.

What is claimed is:

1. A collimated atomic beam generator, comprising:
an atomic vapor chamber comprising an atomic vapor source;
a collimator plate comprising a first side facing the atomic vapor chamber, an opposing second side, and a plurality of channels extending between the first side and the second side; and
an insulative adhesive layer positioned between and coupling the atomic vapor chamber to the collimator plate,
wherein the collimator plate is configured to collimate atomic vapors generated by the atomic vapor source in the atomic vapor chamber.

2. The collimated atomic beam generator of claim 1, wherein the atomic vapor source comprises an alkali dispenser.

3. The collimated atomic beam generator of claim 2, wherein the alkali dispenser is a Rubidium chromate dispenser.

4. The collimated atomic beam generator of claim 1, wherein the insulative adhesive layer is configured to provide thermal shielding to the collimator plate from the atomic vapor chamber.

5. The collimated atomic beam generator of claim 1, wherein the insulative adhesive layer is configured to provide electrical shielding to the collimator plate from the atomic vapor chamber.

6. The collimated atomic beam generator of claim 1, wherein the adhesive layer creates a hermetic seal between the atomic vapor chamber and the collimator plate.

7. The collimated atomic beam generator of claim 1, wherein the insulative adhesive layer has a thickness of between 0.5 mm and 5.0 mm.

8. The collimated atomic beam generator of claim 1, wherein the plurality of channels have a first end proximate the first side of the collimator plate and a second end proximate the second side of the collimator plate, wherein a cross-sectional area of the channels proximate the first ends is greater than a cross-sectional area of the channels proximate the second ends.

9. The collimated atomic beam generator of claim 1, wherein the insulative adhesive layer comprises a ceramic adhesive.

10. The collimated atomic beam generator of claim 9, wherein the ceramic adhesive comprises a dispersion of aluminum oxide in an inorganic silicate aqueous solution.

11. The collimated atomic beam generator of claim 1, wherein the insulative adhesive layer has a thermal conductivity of between 0 and 35 Watts/meter-Kelvin.

12. The collimated atomic beam generator of claim 1, wherein the insulative adhesive layer has an electrical conductivity of between 0 and 100,0000 Siemens/meter.

13. The collimated atomic beam generator of claim 1, further comprising a current input and a current output electrically coupled to the atomic vapor chamber, such that an electrical current received at the current input traverses through the atomic vapor chamber to stimulate the atomic vapor source and exits the current output.

14. A collimated atomic beam generator, comprising:
an atomic vapor chamber comprising an atomic vapor source;
a collimator plate comprising a plurality of channels extending therethrough;
an insulative layer positioned between and coupling the collimator plate to the atomic vapor chamber;
a current input electrically coupled to the atomic vapor chamber; and
a current output electrically coupled to the atomic vapor chamber, such that an electrical current received at the current input traverses through the atomic vapor chamber to stimulate the atomic vapor source and exits the current output.
wherein the atomic vapor source is configured to generate an atomic vapor in response to the electrical stimulus, and
wherein the collimator plate is configured to collimate the atomic vapor as it passes through the plurality of channels.

15. The collimated atomic beam generator of claim 14, wherein the atomic vapor source comprises an alkali dispenser.

16. The collimated atomic beam generator of claim 14, wherein the insulative layer is configured to provide thermal and electrical shielding to the collimator plate from the atomic vapor chamber.

17. The collimated atomic beam generator of claim 14, wherein the insulative layer creates a hermetic seal between the atomic vapor chamber and the collimator plate.

18. The collimated atomic beam generator of claim 14, wherein the insulative layer has a thickness of between 0.5 mm and 5.0 mm.

19. The collimated atomic beam generator of claim 14, wherein the insulative layer has a thermal conductivity of between 0 and 35 Watts/meter-Kelvin.

20. The collimated atomic beam generator of claim 14, wherein the insulative layer has an electrical conductivity of between 0 and 100,0000 Siemens/meter.
